(19) United States
(12) Patent Application Publication
(10) Pub. No.: US 2007/0151916 A1
(43) Pub. Date: Jul. 5, 2007

(54) NETWORK FOR SUPPORTING SPIRAL WOUND MEMBRANE CARTRIDGES FOR SUBMERGED OPERATION

(75) Inventors: Peter H. Knappe, Santa Barbara, CA (US); Ronald Magnani, Arroyo Grande, CA (US); Ryan Kwast, Santa Barbara, CA (US); Jonathon Magnani, Arroyo Grande, CA (US)

Correspondence Address: FITCH EVEN TABIN AND FLANNERY, 120 SOUTH LA SALLE STREET, SUITE 1600, CHICAGO, IL, 60603-3406, US

(73) Assignee: TRISEP CORPORATION, Goleta, CA (US)

(21) Appl. No.: 11/561,819

(22) Filed: Nov. 20, 2006

Related U.S. Application Data
(63) Continuation of application No. PCT/US05/18291, filed on May 25, 2005.
(60) Provisional application No. 60/574,846, filed on May 26, 2004.

(51) Int. Cl. B01D 63/00

(52) U.S. Cl. 210/321.74; 210/321.76; 210/321.83; 210/321.85

(57) ABSTRACT

Methods and apparatus are provided for positioning a plurality of cylindrical spirally wound membrane filtration elements in a body of aqueous feedstock employing manifold conduits that support vertically aligned filtration elements via short lengths of pipe. Efficient and effective connections are made between the ends of such support pipes and the adjacent end of each filtration element by bayonet-type fittings, which allow straightforward, detachable interconnection by axially moving the cylindrical element into place and then rotating the element a quarter turn. Support in this manner provides full access to the open lower ends of the element through which, during operation, streams of rising gas bubbles are caused to pass, fed from underlying bubblers or the like. The manifold conduits may be located either above or below the preferably vertically oriented filtration elements.

This application claims priority from U.S. Provisional Application Ser. No. 60/574,846, filed May 26, 2004.

This invention relates to a method, a network, and a system incorporating same for filtering liquid feedstocks using a plurality of submerged spiral wound membrane elements or cartridges, and more particularly to a method and network for supporting a plurality of spiral wound membrane elements for submerged operation as a filtration array for treating an aqueous feedstock.

### BACKGROUND OF THE INVENTION

Tertiary treatment of municipal sewage is a common wastewater application for ultrafiltration and microfiltration membranes; however, such systems need to be capable of operating on high suspended solids feedwaters while having a long life. Suspended solids that need to be removed may be materials that cause turbidity, such as bacteria, cysts and oocysts, viruses, colloidal material, such as iron oxides, clay, silt, sand and other insoluble impurities. Municipal sewage secondary treatment effluent typically has turbidity levels of 5 to 10 NTU with a suspended solids count of 10 to 20 parts per million (ppm). For membrane technology to be economically competitive in a tertiary treatment process, it should operate at sustained permeate flux rates of 15 to 30 gallons per square foot per day (gfd), while requiring chemical cleaning at a frequency of not more than once per month.

Historically, such difficult applications as treating feed solutions high in organic and suspended solids have employed hollow fiber, capillary, or tubular element designs because spiral wound membranes have heretofore required excessive net drive pressures to produce flow rates competitive with existing hollow fiber technology. On the other hand, hollow fiber and tubular membranes are often plagued with mechanical weaknesses and a high capital cost due to low packing density; thus, the ability to effectively deploy arrays of spiral wound membrane elements would offer an economically attractive filtration alternative because of its greater mechanical durability.

A submerged membrane system is shown in FIG. 6 of WO 00/78436 patent application (28 Dec. 2000) wherein a spirally wound membrane element is immersed in a tank that is filled with a body of water to be filtered. Required transmembrane pressure (TMP) is supplied by a vacuum pump that creates a vacuum which is in addition to any contribution from the static head. Alternatively, static liquid heads alone have been used to generate feed pressures for submerged filtration, see U.S. Pat. No. 5,916,441. Typical ultrafiltration or microfiltration hollow fiber and spiral wound membrane units operate at TMPs of from about 10 to substantially greater than 30 pounds per square inch (psi); however, low pressure, sheet-like membranes are now available for incorporation into ultralow pressure apparatus. As such, it should be possible to operate at a TMP of about 5 psi or less, still produce high permeate flux rates when operated at low pressure in such a submerged configuration.

Very generally, a spiral wound membrane element or cartridge contains a permeate carrier sheet, a membrane filter sheet that is adhesively bonded to the permeate carrier sheet (usually to both surfaces thereof to create an envelope about it), and a feed spacer sheet which separates two facing membrane filter layer sheets which are wound about a porous permeate collection tube. High flux membranes are generally formed of polyethersulfone (PES), polysulfone (PSF), polyvinylidene fluoride (PVDF), or polyacrylonitrile (PAN) because these membranes are generally recognized in the industry to make excellent MF and UF membranes with high flux rates, good chemical resistance and good physical durability. Other polymers such as polypropylene, polyethylene, and chlorinated polyethylene may also be prospectively used to construct such membranes. A permeate carrier sheet is attached to a permeate collection tube, and an adhesive seal is applied to the permeate carrier sheet along its side and end edges, either before or as a membrane filter sheet-feed spacer sandwich is being pressed into juxtaposition with the permeate carrier sheet. The permeate carrier sheet, the membrane filter layer sheet, and the feed spacer sheet thus form the lay-up that is then wrapped around the permeate collection tube. The membrane filtration sheets act as a barrier, filtering out solids from an aqueous feed solution being treated to provide purified water permeate.

U.S. Pat. No. 5,607,593 teaches an installation for producing potable water which uses submerged filtering membranes in the form of cartridges of hollow fibers. The cartridges are supported on a horizontal wall, and the permeate exits the bottom of each cartridge and flows through the wall into an underlying permeate chamber. U.S. Pat. No. 6,348,148 discloses a system for producing potable water from seawater which supports a plurality of pressure hulls below the surface and connects the hulls to a permeate network for delivering potable water to the shore. Each of the hulls includes a plurality of membrane devices that create aqueous permeate. Seawater enters the hulls and permeates through the membranes creating potable water which is withdrawn through the network, while the concentrated brine is discharged in a manner so as to not mix with the seawater being supplied to the individual hulls.

A series of U.S. patents issued to Zenon Environmental, Inc., i.e. U.S. Pat. Nos. 6,245,239, 6,325,928, 6,375,848 and 6,620,319, each show arrangements for supporting filtration modules that employ hollow fibers in various submerged arrays, with air being supplied at lower locations through gas distributors to discharge streams of rising bubbles; however, these arrangements are not appropriate or adaptable to supporting arrays of cylindrical, spiral wound, membrane elements.

None of the foregoing arrangements are particularly well suited for creating an effective array of cylindrical, spiral wound elements or cartridges that can be submerged in a zone of aqueous feedstock for filtering to create purified water. Accordingly, efforts were made to design better arrangements that would facilitate efficient operation by incorporating a large amount of membrane surface area within a tank or chamber of a given size and to allow removal and replacement of individual cylindrical elements without difficulty when needed or desired.

### SUMMARY OF THE INVENTION

The invention provides a method for supporting and interconnecting a plurality of spiral wound elements or cartridges in a submerged environment within a tank which may be open at the top. The cylindrical elements are designed with an end cap at at least one end thereof through which end the permeate is removed; the opposite end is open to upward flow of feedstock. A permeate manifold is provided to remove the permeate from the central tube of each element, and the element itself is supported from the permeate manifold by a connection with support piping that extends from the manifold. The connection creates a seal between the permeate tube and the support pipe, while a bayonet-type fitting locks the end cap in place on the pipe. A filtration network is thus provided which incorporates a plurality of supported and interconnected, spiral wound elements in an array which can be disposed or submerged within a tank. The manifold includes a linear conduit from which a plurality of support pipes extend generally radially. Permeate flows through the individual support tubes and is collected in the linear conduit. Each one of the support tubes is sealed with a permeate tube from a spiral wound element in an arrangement which allows the element to be quickly connected or disconnected. The cylindrical elements may hang vertically downward from an overlying manifold/support tube arrangement, or they may be supported so as to extend upward from an underlying manifold.

### BRIEF DESCRIPTION OF THE DRAWINGS

FIG. 1 is a diagrammatic perspective view showing a filtration installation wherein an open top tank is filled with an array made up of a plurality of rows of networks of cylindrical spiral wound elements vertically aligned and suspended from the parallel manifold conduits which support them in an environment where they are submerged in the feedstock being supplied to the open top tank.

FIG. 2 is a schematic showing the supply of feedstock to an upper region in the tank holding the array of parallel networks of spiral wound filtration elements the removal of permeate through the manifold system, the removal of more concentrated feedstock containing settling solids from a location near the bottom of the tank, and the supply of air to plurality of bubblers disposed vertically below the array of vertically aligned filtration elements to provide air scouring.

FIG. 3 is a fragmentary perspective view showing four vertically aligned spiral wound filtration elements depending from a manifold conduit.

FIG. 4 is an enlarged fragmentary perspective view taken from a different angle of the upper portion of the arrangement illustrated in FIG. 3.

FIG. 5 is a front view of an end cap (removed from the element) and support pipe combination from one of the element assemblies shown in FIG. 4.

FIG. 6 is a perspective view of the end cap shown in FIG. 5.

FIG. 7 is a perspective view of the support pipe alone that is shown in FIG. 6.

FIG. 8 is a partial cross-sectional view taken generally along the lines of 8-8 of FIG. 9 with the permeate outlet tube from the spiral wound cartridge shown in place in the support pipe that is broken away.

FIG. 8A is a schematic fragmentary perspective view showing a spiral wound filtration element during its manufacture.

FIG. 9 is a plan view of the object shown in FIG. 5.

FIG. 10 is an enlarged fragmentary view taken through the detent of the bayonet-type connection as generally shown in FIG. 8, at the location indicated by the section line 10-10 of FIG. 6.

FIG. 11 is a fragmentary perspective view similar to FIG. 3 of an alternative embodiment wherein the elements are supported so as to extend above the manifold conduits.

FIG. 12 is an enlarged fragmentary sectional view of a portion of the structure shown in FIG. 11 taken generally along line 12-12 of FIG. 11.

### DETAILED DESCRIPTION OF THE PREFERRED EMBODIMENTS

The invention provides methods and support networks for filtration of liquid feedstocks, preferably liquid feedstocks that are high in suspended solids, which are effective to produce permeate that is lean in suspended solids at an elevated production rate for a sustained period of operation before shutdown for substantial cleaning is needed in order to continue permeate production at a desired high rate of flux. Effective operation can be achieved with a TMP as low as about 0.5 psi (about 25 mm of Hg) using specially designed spiral wound elements that incorporate high flow, low pressure membranes, although the use of higher TMPs for increased flux are preferred. In this respect, a TMP of at least about one psi, e.g. about 2 to 5 psi, is preferred, while of course still higher TMPs may certainly be used, although such may well require additional power input and may encounter a higher rate of fouling. Examples of such elements are described in copending U.S. Application Ser. No. 60/535,295, filed Jan. 9, 2004, entitled “Submerged Operation with Low-Fouling, High-Flow, Low-Energy Spiral Wound Membrane Cartridges.”

As previously mentioned, the liquid feedstock that is being treated using the methods or systems of the invention may be any of a wide variety of feedstocks such as would be commonly treated in a system such as this, ranging from groundwater or surfacewater supplies to be used for drinking water through all types of wastewater, both industrial and municipal; they may also treat feed that is to be supplied to a membrane bioreactor (MBR). When, for example, the feedstock is from a municipal wastewater treatment facility, it will generally be supplied from a secondary treatment stage and will still be fairly high in suspended solids. The invention may also be used as a membrane bioreactor, for example, where it might be employed to treat municipal sewage in the primary wastewater treatment stage, or it might take effluent from a primary or secondary wastewater treatment stage. Thus the feedstock may or may not have undergone prior primary or secondary treatment where some substantial settling should have occurred, and it may contain very high suspended solids, e.g. 10,000-15,000 ppm, as well as high organic loading. As a part of such an MBR, there may be aerobic and/or anaerobic section(s) and an anioxic section which would reduce nitrate to nitrogen gas.

Although it can thus be seen that the invention is suitable for use in systems for treating a variety of different aqueous feedstocks, it is felt that such systems may have a particular advantage in being able to efficiently treat feedstocks having relatively high suspended solids and/or relatively high turbidity, e.g., aqueous feedstocks having suspended solids in amounts of 1,000 ppm and above and/or a turbidity of about 10 NTU or above. Very generally, an aqueous feedstock having suspended solids at a level of about 10 to about 50 ppm would be considered to contain a relatively high amount of suspended solids; similarly, wastewater having an NTU of about 3 to about 20 would be considered to have a turbidity that is relatively high. On the other hand, wastewater having suspended solids not greater than about 5 ppm might be referred to as being lean in suspended solids, and wastewater having a turbidity not greater than about 3 NTU might be referred to as being low in turbidity.

It is preferred that appropriate microfiltration or ultrafiltration membrane sheet material be employed in the elements that will provide a flux of between about 20 and 100 gfd per psi of TMP when tested on DI water or the like; preferably the membrane should exhibit a clean water flux of at least 50 gfd per psi. Such membranes are commercially available; for example, a polyethersulfone membrane sold as the UB50 membrane by TriSep Corporation of Goleta, Calif. has a clean water flux rate of about 50 gfd per psi and may be employed. Details of exemplary spiral wound elements are found in the '436 International Application mentioned hereinbefore.

Various submerged arrangements can be used to produce the desired net TMP that will drive the filtration process including both partial and complete submergence. For example, such can be provided through any suitable type of vacuum pump or even through an aspirator; and in such case, if desired, the cartridge may be only partially submerged with its upper end extending a few inches above the surface where the rising bubble stream will effect liquid overflow from the open upper end. However, rather than using such an arrangement that requires energy for its operation to provide the TMP, in some instances submerging the elements a distance sufficient to create a significant liquid level of water above the height of the element will provide sufficient drive pressure to satisfactorily carry out the filtration method. To effectively accomplish the use of a static head of water for the TMP, the permeate being produced is removed to an atmospheric tank or the like at a level that is lower than the liquid level in the tank and preferably lower than the level of the element itself. Such removal can be conveniently done through a fitting in the sidewall at such a level, or in the bottom of the tank, and the amount of TMP can then be controlled by adjusting the height of the water in the tank. Should the TMP be too high as a result of substantial submergence, a regulating valve in the permeate outlet line can be used to reduce it to the desired value. Very generally, each 2.3 feet (0.7 meter) of water corresponds to a pressure of about 1 psi (0.07 bar). Accordingly, a liquid head in the tank in the range of 6-10 feet would deliver a TMP of about 2.6 to about 4.3 psi. There are further advantages to using liquid head instead of vacuum to provide the TMP; these flow from simplification of the overall system and elimination of piping, valving, instrumentation and/or pumps. The use of the arrangement depicted in FIG. 11 where the manifold underlies the upstanding elements may be preferred when it is desired to take advantage of liquid head.

Periodic back flushing using permeate has frequently been used to remove accumulated solids that build up on the surface of the membrane or other filtration element. In some cases, cleaning chemicals are injected into and mixed with the permeate water used for backwashing to aid in the removal of suspended solids and disinfection of the membrane surface. It is now felt that with certain element designs, certain feedstocks may be treated without back flushing at all (or at least back flushing that uses a substantial amount of permeate); such achievement is obtained by employing alternating periods of bubbling and idling, wherein permeate flow is shut off while the bubbling continues. Such continued bubbling without any permeate intrusion through the surface of the membrane has been found to exaggerate the scrubbing or scouring action of the bubbles on the membrane surface, thus tending to increase their effectiveness from the standpoint of accumulated solids removal, and carrying those removed solids upward out the open top of the cartridge. Because there is no liquid simultaneously being withdrawn from the tank, the tank itself becomes more quiescent in those regions unaffected by the bubbling, and as a result, suspended solids have a tendency to settle to the bottom of the tank. Solids removal may be achieved through the employment of scrapers or the like, as well known in this art; however, in most instances, the removal of some feedstock from a bottom or near bottom location in the tank is effective to remove settled solids without the need for such ancillary settling/scraping devices. Such withdrawal of liquid is best described in terms of its proportion to the supply of liquid to the tank because it is desired that the overall withdrawal of permeate and high-solids feedstock be such that the liquid level in the tank remains at about the same height. Typically, the withdrawal of feed solution from such a region at or near the bottom of the tank, where it will include a relatively high amount of suspended solids, is not greater than about 10% of the rate at which the feedstock is being introduced into the tank. Generally, the supply of feed and the withdrawal to drain will be continuous, even during those periods when permeate withdrawal ceases because intermittent operation is being employed to effect membrane idling as described hereinafter. However, if desired, all flow could cease during those intermittent periods and only bubbling be carried out, but such is not felt necessary as slight fluctuations in the level of the tank should be not detrimental.

The above-mentioned operations depend upon the generation of bubbles as a key element. Bubble velocity and air flow rates are variables that are controlled to achieve high efficiency; however, a wide variety of gas delivery devices may be employed at locations below the generally vertically aligned cartridges to provide the bubbling desired. These may range from a simple open pipe to other types of sophisticated diffusers having porous sintered plates or patterns of perforations that will result in more uniform bubbling or in a desired pattern of bubbles of relatively similar size. It is of course realized, that the generation of air bubbles through the use of a blower or a compressor or the like involves some expense in the expenditure of energy, and in an effort to truly minimize energy expenditure in the operation of these systems and methods, it has been found that using aeration only on a periodic basis, if appropriately regulated, can still sustain the rates of flux desired. When such periodic bubbling is employed, alternating periods of bubbling and non-bubbling of at least about 3 minutes are preferably used, and such periods preferably do not exceed about 5 minutes. Accordingly, operating using such on/off periods, for example with the bubbling on only about 75% of the time, or even for as little as only 25% to 50% of the time, can still, under many conditions, stabilize permeate fluxes in the range desired. When such periodic bubbling is employed alternating periods of bubbling and non-bubbling of at least about 3 minutes are preferably used and such periods preferably do not exceed about 5 minutes. Fluxes achieved in such systems are preferably at least about 10 gfd per psi of TMP (246 lmh/bar), and oftentimes fluxes double that rate can be achieved.

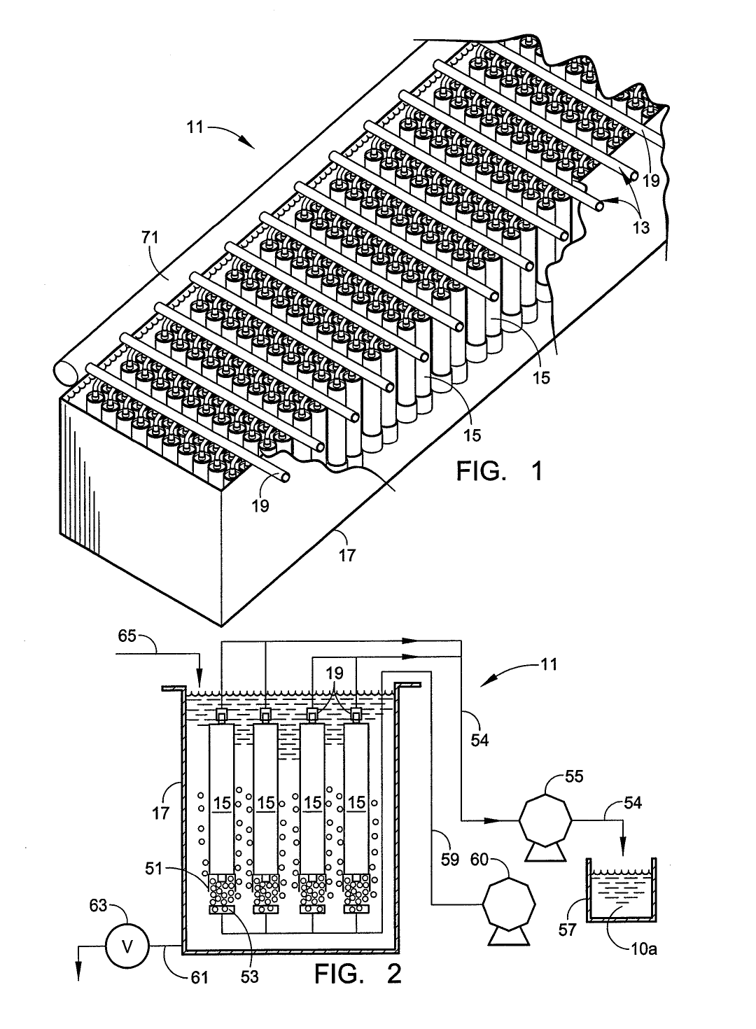

One preferred embodiment is illustrated in FIG. 1 and the accompanying drawings where there is shown a filtration system 11 which submerges a plurality of filtration networks 13 to provide an overall array of vertically oriented, cylindrical, spiral wound filtration elements 15 in a tank 17. It is common that an open-top tank 17 of rectangular shape is provided; however, it should be understood that the tank may be closed if desired and may have any desired shape. Each of the plurality of networks 13 employs a central manifold conduit 19, with these conduits being aligned in a substantially parallel relationship with one another for economy of space. It is understood that it is usually desirable to provide a large amount of membrane surface area in a given volume; thus, it is preferred to use spiral wound membrane elements 15, which themselves provide large amounts of membrane surface area per unit volume, and which are aligned in regular, preferably vertical, spaced relationship in the working array. The network conduits 19 serve as structural members; they are in turn suitably supported, preferably in substantially horizontal orientation. In this embodiment, they extend from side to side across the tank 17; they in turn support the cylindrical filtration elements 15 in depending relationship thereto. The manifold conduits 19 can be formed of any suitable material having structural strength and corrosion resistance such as to endure operation in such an aqueous environment as will be experienced when filtering a variety of feedstocks, which may include municipal sewage and/or industrial waste products. Although polymeric materials that have sufficient structural strength may be employed, corrosion-resistant metal products are preferred, and stainless steel is an example of one particularly preferred material.

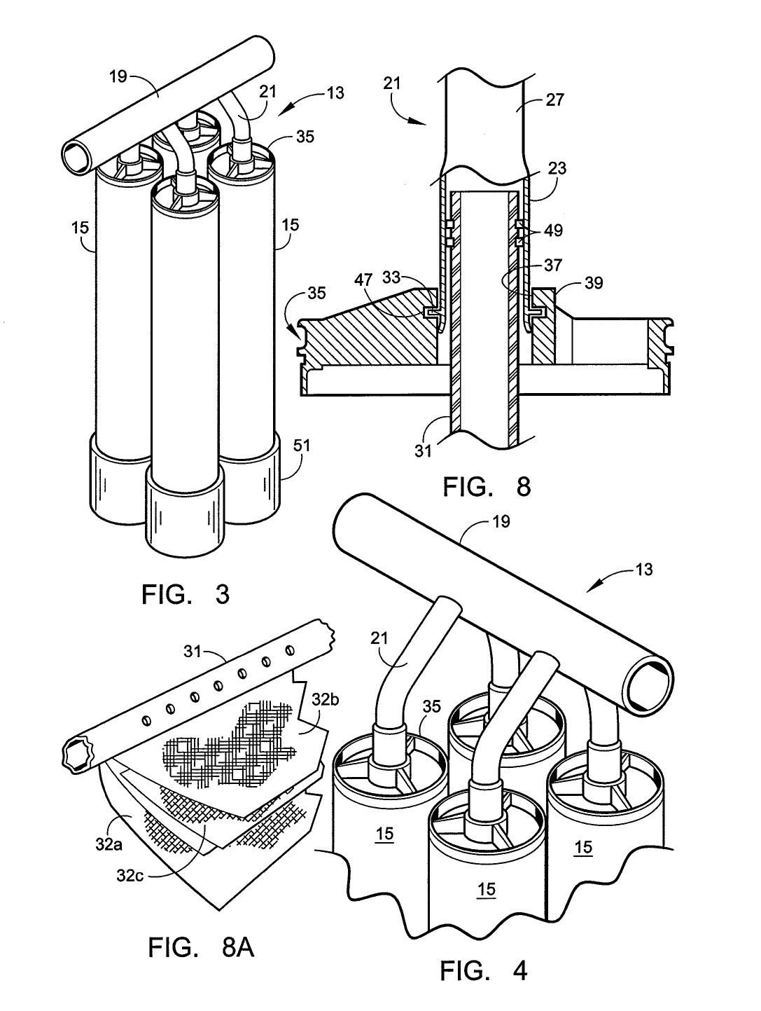

Openings are created in the sidewall of the horizontal stainless steel conduit 19 at regular intervals along its length, and preferably the pattern of openings is such that pairs of openings are provided at the same axial locations along the conduit to create the regular arrangement that is seen in FIG. 3. However, any desired pattern can be used; for example, the openings on the opposite vertical halves of the conduit might be staggered so that each opening would be located an equal distance from the two closest openings on the opposite side of the conduit. Although the angle between pairs of openings is not considered to be critical, the centerlines of the circular openings in the sidewall are preferably located at an angle to each other between about 90 degrees and 150 degrees, and preferably at an angle of about 120 degrees, plus or minus 5 degrees.

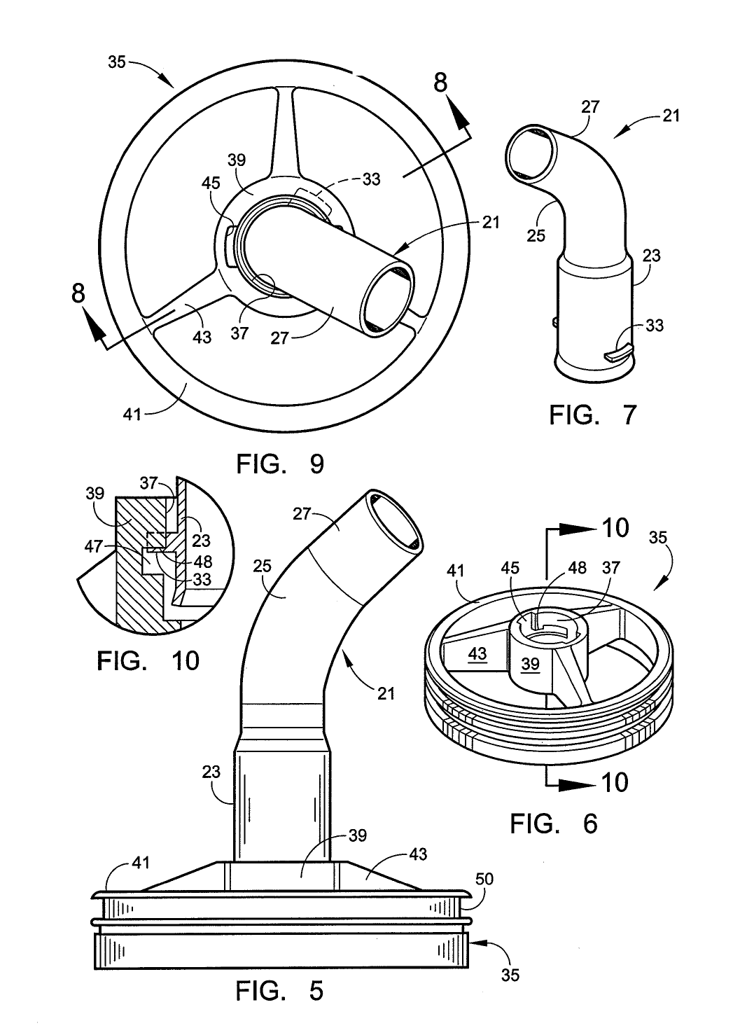

Piping is affixed to the network conduit 19 so as to radially extend from the conduit (see FIG. 4) and to provide fluid interconnection between it and each element 15. As best seen in FIG. 5, the piping is in the form of a plurality of short arcuate support pipes 21 each of which has a lower vertical portion 23, a central curved portion 25 and an upper end portion 27 that is received in the opening in the network conduit and welded or otherwise affixed thereto. The length and orientation of this generally arcuate pipe 21 is such as to space the underlying spiral wound element 15 a desired distance from the vertical plane of the network conduit centerline so that it does not interfere with the next adjacent element 15 being supported on the network conduit. It is felt that the vertically oriented, spiral wound elements 15 should be spaced apart from one another by locating them on centers equal to the outer diameter of the spiral wound elements plus between about 2 and about 4 centimeters. In one embodiment, the spacing is such that the distance between adjacent elements 15 in the same row and in the neighboring row is about 2.5 centimeters, which is considered satisfactory.

Each support pipe 21 has a straight lower base section 23 and a straight upper section 27 which are interconnected by an elbow section 25 of arcuate shape so that the two straight sections are oriented at about 60 degrees to each other. The end of the upper portion 27, as indicated, is welded or otherwise permanently affixed to the manifold conduit 19 so that the support pipe resides in a vertical plane and the base section 23 is oriented vertically. The base section 23 is preferably swaged to a larger diameter, as perhaps best seen in FIGS. 5 and 7, so that it is appropriately sized to receive the upper end of a permeate outlet tube 31 (see FIG. 8) extending from the spiral wound element 15 that it will support. To lock the element 15 in a supported arrangement on the support pipe, a pair of generally flat, radially extending tabs or ears 33 (see FIG. 7) are welded or otherwise suitably affixed to the exterior surface of the swaged-out base portion 23 of the support pipe; they function as part of a bayonet fitting as explained in more detail hereinafter.

As best seen in FIG. 4, each of the spirally wound cylindrical filtration elements 15 has an open upper end cap 35 that contains a central socket 37 (FIG. 6) in a raised boss portion 39 that is connected to a short tubular rim 41 by three arms 43 arranged in a spoke-like style, thus leaving a major portion of the end surface open to liquid flow. In this respect, the relatively open end cap 35 resembles the anti-telescoping devices commonly used at the opposite ends of spiral wound tubular filtration elements. The end cap is suitably attached to the tubular outer casing of the element 15, adhesively or by a fiberglass outer wrap or in any other suitable manner so that it becomes an integral part of the element. The use of three spoke-like arms 43 provides a major open area at the top of the element that allows fluid communication between the axially extending passageways throughout the element and the feedstock reservoir in the tank.

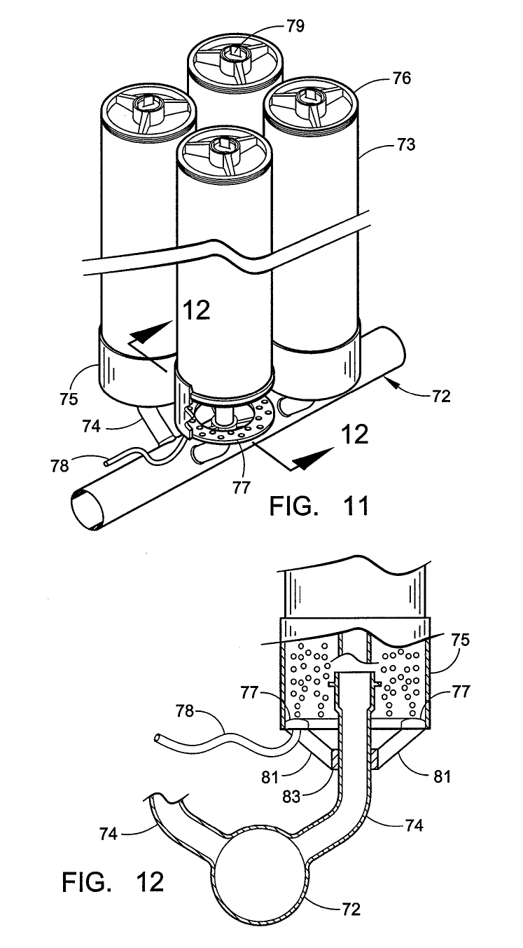

As seen in FIGS. 6 and 9, the socket 37 fitting contains a pair of oppositely disposed notches 45 which receive the radial tabs 33 on the exterior of the swaged base portion 23 of the arcuate pipe when a filtration element 15 is moved vertically upward to mate it with the support pipe from the overlying manifold conduit. When the element is inserted so that the tabs 33 at the end of the support pipe have reached the bottom of the notches 45 in the socket 37, the tabs are aligned with an interrupted horizontal groove 47 (FIGS. 8 and 10) that is suitably molded or otherwise cut in the interior surface of the boss portion 39 of the end cap that constitutes the socket. A keeper or detent 48 is provided at the entrance to groove to narrow the entrance and serve as a lock. The cylindrical element 15 is then rotated about 45-90 degrees to move the tabs 33 in the groove 47 away from the entry notches 45 past the keepers 48 to a position as shown in the dotted outline in FIG. 9. Gravity causes the tabs 33 to seat against the upper wall of the groove 47 where the keeper 48 securely locks that bayonet fitting and secures the depending filtration element to the support pipe as it must be both raised and turned to disengage it thereafter.

As best seen in FIG. 8, the central permeate outlet tube 31 from the spiral wound element 15 extends through the center of the boss 39 of the end cap 35 and is sealed to interior surface of the arcuate support pipe 21 so as to be fluidtight. The end region of the permeate tube 31 is formed with a pair of grooves in which O-rings 49 of round or square cross section are received; the sizing is such that the outlet end section of the permeate tube is received within the swaged base section 23 of the support pipe, with the pair of O-rings creating a liquidtight seal therebetween. Alternatively, a pair of interior grooves could be provided in the swaged section of the support pipe that would carry a pair of O-rings. Thus, with the filtration element 15 locked in place, there is communication from the spiral permeate channels, which are provided in the filtration element by permeate carrier sheet material 32a spirally wound about the porous central section of the permeate collection tube 31 along with a folded sheet of membrane filter material 32b and a sheet of feed spacer sheet material 32c (see FIG. 8A), and the outlet end of the permeate tube, which continues through the short arcuate support pipe 21 and into the manifold conduit 19. The lower or bottom end of the permeate tube 31 is sealed, as by a suitable plug (not shown) such as that shown in FIG. 11 and described hereinafter. If it is desired, for convenience of manufacturing, to construct both ends of the element the same, such a plug which mates to the bayonet fitting may optionally be used. In any event, the upper and lower end faces of the spirally wound membrane element are otherwise open to liquid feedstock flow, allowing the flow of bubbles and liquid feedstock axially upward through the multiple passageways in the cylindrical elements 15 provided by the feed spacer sheets. O-rings are seated in the circular exterior groove 50 in the bottom end caps and used to seal to bubble collection skirts 51 which may be cylindrical or slightly frustoconical. Thus, when the array is complete, a multitude of spiral wound elements are supported in vertical orientation within an open top tank 17 (FIG. 1) or the like, preferably submerged below the surface of the feedstock and located above gas distribution devices 53 (FIG. 2) that provide streams of bubbles in the vicinity of each of the elements, which bubbles are directed into the open lower ends by the collectors 51 which gather the rising bubbles and are long enough to assure that a large proportion of the bubbles will not be directed outward and rise in the regions of the tank adjacent the elements, rather than pass through them.

As previously mentioned, if it is desired to use the static liquid head of the body of feedstock to supply the TMP, or part of the TMP, the array is simply located at a lower level in a tank of perhaps greater depth (as illustrated in the copending application mentioned hereinbefore). In the FIG. 2 illustrated arrangement, a source of vacuum is used to provide the desired TMP by creating a slight negative pressure within the interconnected manifold conduits 19 via a line 54 which leads to a permeate reservoir 57. Such vacuum can be provided simply by a suitable pump 55 that draws suction therefrom or by a small compressor. The arrangement is such that the TMP promotes the flow of permeate from the feed passageways 32c in the spiral element 15 through the membrane 32b and into the permeate passageways 32a. Within the permeate passageways, the water flows centrally toward and into the permeate tube 31, then through the arcuate support pipes 21, the manifold conduits 19, and eventually into the line 54 leading to the permeate collection tank 57. The flow of permeate through the membrane depletes the liquid in the feed passageways causing replenishment by a rising head of water through the open bottom end caps of the spirally wound elements 15. This flow is enhanced by the rising streams of bubbles which are collected by the bubble collection skirts 51 attached in encircling relationship; these bubbles, in their passage through the feed passageways of the spacer material 32c, scour solids which would otherwise have a tendency to deposit or cake on the membrane and carry them out the top of the open upper ends of the elements along with the portion of the feedstock that did not permeate through the membrane. The air for feeding the gas distribution devices or bubblers 53 is suitably provided through a line 59 leading from a compressor 60 or a cylinder of compressed air or the like.

As operation continues, the suspended solids that are rejected by the membrane begin to gravitate to the bottom region of the tank 17, and they can be removed by any suitable manner well-known in this art. Although scrapers or the like might be used along with a sloping bottom to focus the collection of settled solids, it has been found that the simple withdrawal of a stream of more concentrated solids-containing feedstock from the bottom region of the tank via an outlet line 61 containing an adjustable valve 63 leading to drain. By removing an amount equal to between about 5% and 10% of the volume of flow 65 into the tank, feedstock of suitable quality for filtration will be maintained, and build-up of solids in the tank 17 will be prevented. The remainder of the liquid inflow 65 is of course removed through the creation of permeate, which is usually the purpose of the overall installation.

If desired and as taught in '436 international application, periodic backflushing can be utilized to further assure that membrane flux remains at the desired high level. A pump or compressor or cylinder of compressed gas or the like (not shown) may be used to cause the flow of fluid in reverse direction through the line 54 and the manifold conduits 19 and the permeate piping systems so as to effect momentary flow through the sheetlike membranes 32b in the opposite direction that removes solids that might have accumulated on the surface thereof There may well be sufficient residual permeate in the manifolds 19 and all the associated piping to provide the desired volume of back flush permeate flow; however, a small tank (not shown) can be provided in the line 54 for situations where a greater volume of flow is desired, or suction may alternatively be taken from the permeate reservoir 57. As an alternative to such backflushing, it has been found that, under certain conditions, it is possible to merely idle the filtration modules by halting flow of permeate and allowing the upwardly moving streams of bubbles to scour accumulated solids from the surface of the membranes and the spiral passageways; such may negate the need for any backflushing.

Regardless of the use of periodic backflushing and occasional chemical cleaning which may, if desired, be incorporated into the periodic backflushing, there will always be some maintenance required, and of course, the spiral wound membranes do have a finite lifetime. The support method provided herein not only provides a simple, straightforward, efficient manner of supporting rows of vertically aligned cylindrical filtration elements 15 in a tank 17, but it facilitates quick replacement of an element or a row of elements by simply rotating an element a quarter turn or so to disengage at the bayonet fitting and remove it from its position in the array depending from the manifold conduit 19. Thus, it can be seen that this arrangement not only makes servicing and replacement of these elements quite easy, but the overall arrangement is one having a relatively low capital cost when compared to more elaborate racks and the like that have previously been employed in systems for creating arrays of filtration devices in submerged condition in a tank of aqueous feedstock or the like. From strictly a mechanical standpoint, it has been found that stainless steel tubing made of 316L stainless steel or its equivalent, having about a four inch diameter and a wall thickness of about 3.4 mm, has satisfactory strength to support a double-row of cylindrical spiral wound filtration elements 15 of about nine-inch diameter and about 40 inches in length, which elements may weigh in the vicinity of 30 pounds (14 kg) apiece. The individual arcuate support pipes 21 may be made from stainless steel tubing having a diameter of about 1.5 inches and would be welded to the four inch manifold conduits 19 at the spaced-apart holes or openings; they might extend therefrom at about an angle of 60° to the vertical. The base portion 23 of each support pipe 21 can be swaged to a slightly larger diameter so as to accommodate a permeate outlet tube 31 from the element that may have an outer diameter of about 1.9 inch and that may also have a pair of grooves in its exterior surface, spaced apart about 0.5 inch, each of which will seat an O-ring 49 as shown in FIG. 8. The open end caps 35 are preferably molded from a suitable corrosion-resistant plastic material, such as ABS, to have the desired boss and bayonet fitting type socket, with the three radial arms 43 arranged at angles of about 120° to one another. The bottom end caps and the bubble collection skirts 51 could be made of similar material.

The overall arrangement wherein two or three or 10 or more of these networks 13 of vertically disposed filtration elements 15 are arranged in an open top tank 17 or the like provides an extremely efficient array for treating surface water, wastewater and/or municipal sewerage. As shown in FIG. 1, each of the manifold conduits 19 is connected to a header 71 that physically supports one end of each manifold conduit, runs along a side edge of the tank 17 and connects to the line 54 that leads to the permeate collection chamber 57; in the illustrated arrangement, the line 54 includes a source 55 of vacuum. Thus a simple, effective and economical arrangement is provided for treating an aqueous feedstock by filtration using a multitude of spirally wound membrane elements 15.

Although the invention has been illustrated and described with regard to certain preferred embodiments which constitute the best mode presently known for carrying out the invention, it should be understood various changes and modifications as would be obvious to one having ordinary skill in this art may be made without departing from the scope of the invention which is set forth in the claims appended hereto. For example, although an illustrative embodiment has been described which uses vacuum to create the desired TMP, it should be appreciated that, by submerging the array of elements to a desired depth, static liquid head can provide the TMP to operate effectively.

As an alternative arrangement, the header 71 and the interconnected manifolds may be located below the filtration elements so that the arcuate pipes would extend generally upward and support filtration elements extending upward therefrom, that are aligned vertically above each manifold rather than hanging therefrom. Such an arrangement is illustrated in FIG. 11 which depicts four cylindrical, spirally wound filtration elements 73 having depending collection skirts 75 that are supported above a horizontally extending manifold tube 72. If the cylindrical elements are constructed with end caps 76 of the same construction at both ends, then such elements can be used interchangeably; they may either depend from an overhead manifold 19 as shown in FIG. 4 or extend upward from an underlying manifold tube 72 as shown in FIGS. 1 land 12.

The manifold arrangement which is shown in FIG. 11 is basically the reverse construction shown in FIG. 4. A plurality of pairs of support pipes 74, which contain radial extending tabs near the ends thereof, extend generally upward from the manifold conduit 72 at spaced axial locations. The bayonet fittings incorporated in the bottom end caps 76 are mated to the upper ends of the short support pipes 74 as described hereinbefore, and the upper ends of the permeate tubes are sealed by suitable plugs 79 that are received in the bayonet fitting sockets in the end caps 76 at the upper end of each element 73.

The arrangement at the bottom of each element is best seen in FIG. 12 where the bubble collection skirt 75 has been broken away to show an annular bubbler 77 that is interconnected with each filtration element support arrangement. In the illustrated embodiment, its diameter is proportioned so that it is received just within the confines at the bottom of the depending collection skirt 75. The bubbler 77 may be a hollow toroidal ring, at least the upper surface of which is perforated; it has three radial support arms 81 that join the ring to a central annular boss 83 that fits around a support pipe. If desired a pair of opposed vertical slots can be provided in the interior of the boss 83 to allow the bubbler to be slid downward past the radially extending tabs to facilitate its installation before the filtration element 73 has been supported in place. The bubbler 77 is fed via an air line 78 in the same manner as the feed to the bubblers 53 was described hereinbefore; however, in this arrangement, its location within the confines of the skirt 75 is such that substantially all of the bubbles will be captured within the bubble collection skirts and thus be assured of rising through the feed passageways in the spiral wound filtration element 73 so as to carry out the scouring function that is desired.

The disclosures of all U.S. patents and applications mentioned herein are expressly incorporated herein by reference. Particular features of the invention are emphasized in the claims that follow.

1. A method of supporting and interconnecting a plurality of submerged spiral wound elements in a tank, which method comprises:
a. providing a plurality of spiral wound membrane filtration elements which each include membrane filter sheet material, feed spacer sheet material and permeate carrier sheet material spirally wound about a porous permeate collection tube and confined within a tubular boundary in a generally cylindrical configuration; each said spiral wound element having an end cap on at least one end;
b. providing a permeate manifold for removing permeate from the permeate tube of each said spiral wound membrane element;
c. supporting each said membrane element from said permeate manifold via connection at said end cap with a support pipe that extends from said permeate manifold while an opposite end of said membrane element remains unconnected and wide open to liquid flow therethrough to and/or from the tank;
d. sealing the connection between each said permeate tube and each said support pipe; and
e. locking each said element to said support pipe by axially vertically moving said element into place and then rotating to interengage a detachable, rotatable fitting between said support pipe and said cartridge end cap.

2. The method of claim 1 wherein each said support pipe has two radially extending tabs which interengage within a groove provided within said end cap upon rotating said element.

3. The method of claim 1 wherein said permeate manifold and said support pipes are made from stainless steel and wherein said sealing is carried out through the use of O-ring seals.

4. The method of claim 3 wherein two or more of said support pipes extend from permeate manifold at a given axial location on said permeate manifold.

5. The method of claim 4 wherein said support pipes generally depend from said manifold.

6. The method of claim 4 wherein said support pipes generally extend upward from said manifold which is disposed therebelow.

7. A filtration network incorporating a plurality of supported and interconnected spiral wound elements in a tank for submerged disposition, which network comprises:
a. a plurality of spiral wound membrane filtration elements which each include membrane filter sheet material, feed spacer sheet material and permeate carrier sheet material spirally wound about a porous permeate collection tube and confined within a tubular boundary in a generally cylindrical configuration, each said spiral wound element having an end cap on at least one end;
b. a manifold for collecting permeate from the permeate tube of each of said spiral wound membrane elements;
c. structure for interconnecting and supporting each said element from said permeate manifold so as to be aligned substantially vertically in the tank, which structure includes a plurality of support pipes that extend from said permeate manifold;
d. means for sealing a connection between each said permeate collection tube in each said element and each said support pipe; and
e. a fitting through which each said support pipe and each said end cap are interengaged and by which each said element is detachably locked to said respective support pipe at said one end while an opposite end of each element remains unconnected and wide open to liquid flow therethrough to and/or from the tank.

8. The network of claim 7 where each said support pipe has two radially extending tabs which each interengage within a groove provided within said end cap to lock said element to said support pipe upon rotating said element to which said end cap is affixed.

9. The network of claim 8 wherein said end caps have notches in the end surfaces thereof which provide entry of each said tab to a respective said groove which is arcuate and which has an entrance of reduced vertical dimension to lock said tab therewithin and avoid inadvertent disengagement.

10. The network of claim 9 wherein two or more of said support pipes extend from said permeate manifold at a given axial location on said permeate manifold.

11. The network of claim 10 wherein said support pipes generally depend from said manifold which is overlying and are sealed to said supported element via an O-ring seal.

12. The network of claim 11 wherein said two support pipes have upper straight sections which are aligned at an angle of between about 90° and about 150° to each other.

13. A filtration system for treating an aqueous feedstock, which system comprises:
a tank;
means for supplying aqueous feedstock to said tank;
an array of at least 2 networks, each of which incorporates a plurality of supports for spiral wound elements;
a plurality of spiral wound membrane filtration elements which have a generally cylindrical configuration, said spiral wound elements each having an end cap on at least one end through which a permeate collection tube extends;
each said network including a tubular manifold for collecting permeate from the permeate tube of each said spiral wound membrane element through said supports which are tubular;
said tubular supports connect said end caps on said one end of said elements to said permeate manifold and align and support said elements substantially vertically in the tank while an opposite end of said membrane element remains unconnected and wide open to liquid flow therethrough to and/or from the tank;
means for sealing the connection between each said permeate collection tube and each said tubular support;
said connection between each said tubular support and each said end cap being rotatable, as a result of which each said element axially vertically moving said element into place and then rotating to interengage is detachably locked to said respective support;
means for withdrawing aqueous permeate from each of said manifolds; and
means for removing settled solids from a bottom region of said tank.

14. The system of claim 13 where each said tubular support is a pipe having two radially extending tabs, which tabs each interengage within an arcuate groove provided within said end cap upon rotating said element to which said end cap is affixed.

15. The system of claim 14 wherein said manifold includes a straight elongated tube and two of said tubular supports extend from said manifold tube at a given axial location thereon.

16. The system of claim 15 wherein said tubular supports extend radially from each said manifold tube and have end sections that are vertically oriented.

17. The system of claim 16 wherein the lower end of each said element is open to upward fluid flow, as is each said end cap which is disposed at the upper end thereof, and wherein gas distribution means is provided to create streams of bubbles in said tank at locations below said elements.

18. The system of claim 17 wherein the lower end of each said elements carries a bubble-collection skirt that depends vertically therefrom and gathers rising bubbles to direct them into flow passageways that extend axially through said elements.

19. The system of claim 18 wherein said elements are supported above said tubular manifold and said gas distribution means includes a generally ring-shaped bubbler that is supported on each said tubular support so as to reside generally at the bottom of said bubble collection skirt.

20. The system of claim 19 wherein each said network contains one said manifold tube that extends across said tank, which manifold tubes are parallel to each other and connect at one end to a header from which they are physically supported.

21. A filtration arrangement for operating spiral wound filtration elements in submerged disposition in a body of liquid in a tank in generally vertically aligned orientation, which arrangement comprises:
a. a plurality of spiral wound membrane filtration elements which each include membrane filter sheet material, feed spacer material and permeate carrier sheet material spirally wound about a porous permeate collection tube and confined within a tubular boundary in a generally cylindrical configuration;
b. an end cap on at least the lower end of said element;
c. a bubble-creation device positioned below said end cap;
d. an annular skirt attached to the lower end of each said element for collecting bubbles from the bubble-creation device and directing such bubbles into said spiral wound membrane element;
e. a permeate collection manifold; and
f. means interconnecting said end cap of each said element with said manifold axially vertically moving said element into place and then rotating to interengage to support said element in upwardly extending generally vertical orientation while an opposite end of said membrane element remains unconnected and wide open to liquid flow therethrough to and/or from the tank.

22. The arrangement according to claim 21 wherein there is included a means interconnecting said manifold and said bubble creation device so that said device is disposed within or near a lower entrance into said annular skirt.

23. The arrangement according to claim 22 wherein a support pipe for each filtration element extends generally upward as a part of said manifold and said device is supported by said respective support pipe via said interconnection with said lower end cap.
